(19) United States
(12) Patent Application Publication
(10) Pub. No.: US 2005/0218811 A1
(43) Pub. Date: Oct. 6, 2005

(54) Gas discharge lamp with high-energy vacuum ultraviolet emission

(76) Inventor: Michael B. Schulman, Pittsburgh, PA (US)

Correspondence Address: MINE SAFETY APPLIANCES COMPANY;P.O. BOX 426, PITTSBURGH, PA, 15230, US

(21) Appl. No.: 11/094,700

(22) Filed: Mar. 30, 2005

Related U.S. Application Data
(60) Provisional application No. 60/557,921, filed on Mar. 31, 2004.

(51) Int. Cl. H01J 17/20; H01J 61/12; H01J 61/18

(52) U.S. Cl. 313/637; 313/638

(57) ABSTRACT

A novel VUV lamp is described, in which one or more portions of the lamp enclosure include a VUV transmissive section to transmit VUV radiation. At least one of the VUV transmissive sections is fabricated from crystalline LiCaAlF₆. The entire enclosure of the lamp can, for example, be fabricated from crystalline LiCaAlF₆. Alternatively, a portion of the enclosure other than the VUV transmissive section(s) of the lamp can be fabricated from a material other than LiCaAlF₆. For example, the material can be glass, ceramic or quartz. In one type of embodiment, the lamp's VUV optical radiation output is produced by an electrical gas discharge inside a sealed bulb. In preferred embodiments of this type, the bulb is filled with a low pressure of nitrogen gas or carbon monoxide gas.

### CROSS-REFERENCE TO RELATED APPLICATION

This application claims the benefit of U.S. Provisional Patent Application No. 60/557,921 filed Mar. 31, 2004, the disclosure of which is incorporated herein by reference.

### BACKGROUND OF THE INVENTION

The present invention relates generally to gas discharge lamps, and more particularly to gas discharge lamps which provide an output emission in the vacuum ultraviolet (“VUV”) spectral range.

Gas discharge lamps are employed in general lighting applications as well as specialized electronic instruments. Two advantages of this class of lamps are their ability to generate a steady source of VUV atomic spectral line emission (by selecting an appropriate gas in which to run the discharge), and the very compact sizes which can be achieved. For example, in a photoionization detector (“PID”), a miniature gas discharge lamp is used to produce high-energy VUV photons. Several photoionization detectors with gas discharge lamps are described, for example, in U.S. Pat. Nos. 4,013,913; 4,398,152; 5,561,344; 6,225,633 and 6,646,444; and in German Patent DE 19535216 C1. In one approach, a large high-frequency voltage is applied between electrodes which are adjacent to the gas envelope of the lamp bulb in order to induce an ionization, excitation and photoemission process in the gas which is sealed within the lamp bulb. Some of the resulting VUV photons pass through a VUV-transmissive window in the lamp to illuminate an adjacent volume in which a mixture of ambient gas species is introduced. Depending on their ionization potentials, photoionization of some of the species in the gas mixture can occur. An electrodeless (that is, having no internal electrodes) PID gas discharge lamp is described, for example, in U.S. Pat. No. 5,773,833. The use of a hand-held PID device to detect trace levels of volatile organic compounds (“VOCs”) is one particularly important application of this technique.

VUV optical window materials produce increasing attenuation of the incident photon flux as the photon wavelength decreases below a certain level. Depending on the minimum wavelength that must be transmitted, only a small number of prior-art crystalline materials, such as MgF₂, CaF₂, BaF₂ or LiF have been used as VUV windows for gas discharge lamps. The transmission of these VUV window materials reduces sharply below about 140 nm. The use of a LiF window makes it possible to achieve a maximum emission energy of 11.7-11.8 eV with Ar as the discharge gas. But the LiF optical material is (a) easily degraded by color-center formation (“solarization”), (b) a soft crystal which is difficult to use when high-precision machining and polishing is needed, (c) hygroscopic, (d) chemically unstable when exposed to high humidity in the ambient atmosphere, and (e) difficult to permanently hermetically seal to a glass lamp envelope because of its chemical, thermal and mechanical properties. Indeed, prior-art product specifications for a miniature LiF-window PID gas discharge lamp which is available from RAE Systems, Inc. of Sunnyvale, Calif., indicate that the lamp is limited to an operating life of less than several hundred hours, and a shelf life of only about one month after it is unsealed from the hermetic packaging which is provided by the vendor.

Furthermore, if a gas discharge lamp is operated with its window exposed to hydrocarbon and silicate compounds in the ambient air, the window surface tends to become increasingly contaminated by a surface film which is formed from the photoionization products of these air-borne compounds. This causes the effective lamp output intensity to decrease faster with operating time. The typical maintenance procedure for PID instruments thus requires removal of the gas discharge lamp and cleaning of its window manually when the sensitivity has dropped below a certain level. This involves a substantial risk of window damage for lamps with LiF windows, because of the chemical instability and softness of the LiF crystal material.

Schemes for self-cleaning the lamp window, which rely on operating the VUV lamp during exposure to an oxygen-containing atmosphere to generate the reactive agent ozone, have been described. An enhanced concentration of ozone is purported to loosen or remove organic deposits from the exposed surfaces to some degree. See for example U.S. Pat. No. 6,313,638. However, for high-energy gas discharge lamps with LiF windows, these self-cleaning schemes present particular disadvantages. The method described in U.S. Pat. No. 6,255,633 for producing a self-cleaning action on a VUV lamp window in a PID device requires stopping the sampled gas flow across the face of the lamp window and operating the VUV lamp to produce more ozone. However, for a LiF window this method exacerbates degradation of the LiF material, since said degradation due to color-center formation by VUV radiation is accelerated by operating the gas discharge lamp. When this self-cleaning method is accomplished by operating the high-energy VUV lamp, the repeated self-cleaning cycles will use up a significant fraction of the limited available operating life of the lamp. If the user decides to not clean the LiF window for these reasons, the continuous contamination of the window surface while the lamp is operating will cause the instrument to decrease in sensitivity and go out of calibration more rapidly.

In the prior art, the other material options for applications requiring wavelengths below ˜147 nm have been limited to materials such as MgF₂, CaF₂ or BaF₂. These VUV window materials have improved sealability, cleanability and useful life compared to LiF windows. However, these materials have sharp transmission reductions at cut-off wavelengths, the shortest of which is approximately 115 nm for MgF₂. Only slightly extended transmission in the cut-off region for each material can be achieved by using a thinner window, at the expense of mechanical strength.

For the above reasons it is therefore desirable to develop a class of gas discharge lamps with improved VUV-transmissive windows that will have particular new advantages for photoionization detectors.

### SUMMARY OF THE INVENTION

The present invention provides a VUV lamp including an enclosure containing a discharge gas or gas mixture. One or more portions of the enclosure include a VUV transmissive section to transmit VUV radiation. At least one of the VUV transmissive sections is fabricated from crystalline LiCaAlF₆. The entire enclosure of the lamp can, for example, be fabricated from crystalline LiCaAlF₆. Alternatively, a portion of the enclosure other than the VUV transmissive section(s) of the lamp can be fabricated from a material other than LiCaAlF₆. For example, the enclosure material can be glass, ceramic or quartz. In a preferred embodiment, the bulb is filled with a low pressure of nitrogen gas or carbon monoxide gas.

### BRIEF DESCRIPTION OF THE DRAWINGS

FIG. 1 illustrates an embodiment of a gas discharge lamp of the present invention.

### DETAILED DESCRIPTION OF THE INVENTION

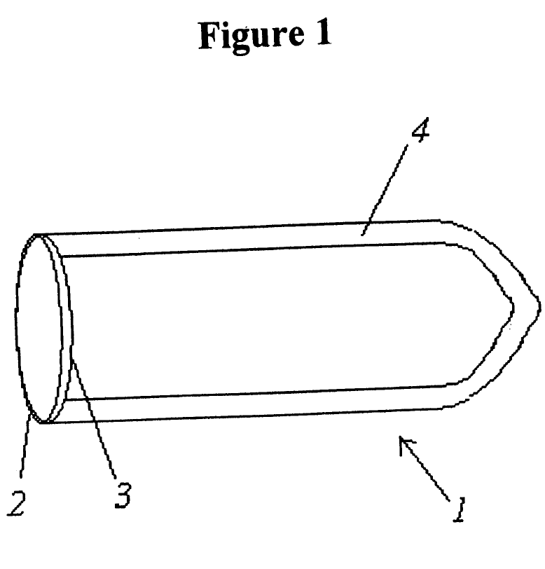

FIG. 1 illustrates an embodiment of a gas discharge lamp 1 of the present invention. The special material chosen for the window 2 is selected for a VUV transmission cut-off energy above 10.8 eV at room temperature, where window 2 is not a pure or doped version of the prior-art crystalline window materials LiF or MgF₂. A low-pressure gas discharge is induced within VUV lamp 1 by applying appropriate voltage levels to the lamp electrodes (not shown), which may be internal (through electrical leads that pass through the hermetically sealed lamp envelope 4), or adjacent externally, as known in the art. If VUV photons between 10.8 eV and the cut-off wavelength of the window are generated by the gas discharge within lamp 1, a fraction of these VUV photons will be transmitted through the window 2 when lamp 1 is operated at room temperature. Furthermore, the crystal material chosen for window 2 is to be chemically stable, sufficiently robust to accept and retain a highly polished surface and a hermetic seal 3, and not subject to solarization.

In order to help maintain the purity of the gas fill for an extended time, an amount of getter material (not shown) can be included inside the lamp envelope 4, as known to those skilled in the art.

In one embodiment, gas discharge lamp 1 is an electrodeless sealed glass tube filled with a particular low-pressure discharge gas or gas mixture as known in the art. One portion or end of the glass lamp tube is sealed with a VUV-transmissive crystalline section or window 2.

Gas discharge lamp 1 can be provided with electrical circuitry (not shown) as known in the art, to supply independent steady or varying voltages to the lamp electrodes (not shown). The discharge in lamp 1 is typically powered at a sinusoidal frequency in the kilohertz to megahertz range, as known in the art. In one method, the amplitude of the sinusoidal lamp voltage can be modulated to reduce the average power to the lamp, as know in the art (see for example U.S. Pat. No. 5,773,833).

The present invention describes a VUV lamp such as VUV lamp 1 which includes an improved window 2 fabricated from crystalline lithium-calcium-aluminum-fluoride LiCaAlF₆ (“LiCaAlF” or “LiCAF”). The lamps of the present invention can, for example, be used in a variety of instruments such as: stand-alone VUV spectrometers, VUV spectrometers used as detectors for analytical instruments, and detectors which use VUV to sense hazardous species in the air [for example photoionization detectors (“PIDs”) and some types of ion mobility spectrometers]. Although most VUV devices have the open VUV path in air at a very low pressure or an N₂ atmosphere, some VUV devices with short path length (for example, “PIDs”) operate in air at or near ambient pressure and humidity. The lamps of the present invention are particularly well suited for use in VUV devices that are intended to monitor for some ambient species or hazard over a long operating life without maintenance and/or in applications with harmful conditions (for example, “PID”). Other applications include devices in which the sample being analyzed is a liquid with contaminants. The lamps of the present invention can be of a type which operates with electrodes inside the lamp envelope, or of a type which operates with external electrodes.

LiCaAlF₆ single crystals have been used as solid-state lasing media when they are specially doped, and the thermomechanical and thermo-optical properties have been characterized. The thermomechanical properties are expected to be adequate for laser applications at low and medium average power. The present inventor has discovered that the use of these materials can be extended to VUV lamps. For example, a sample of LiCaAlF₆ from one crystal manufacturer had adequate transmission to allow for an 11.2-eV PID lamp. LiCaAlF₆ is non-hygroscopic, has more stable chemical properties than LiF, and it is as good as or better than MgF₂ in terms of transmission. In a comparison test, the transmission of MgF₂ reduced sharply compared to LiCaAlF₆ as the wavelength was shortened into the VUV below about 140 nm. The present inventor has determined that LiCaAlF₆ is advantageous as an alternative to LiF windows for achieving a high-energy PID lamp above 10.8 eV, since LiF is solarized by high-energy VUV radiation, and it is degraded by exposure to the humidity in the ambient air.

In one type of embodiment, the lamp's optical radiation output is produced by an electrical gas discharge inside a sealed bulb. In a preferred embodiment of this type, the bulb can be filled with a low pressure of nitrogen gas, which has a multiplet of atomic nitrogen VUV emission lines at a photon energy of 11 eV.

Growth of LiCaAlF₆ crystals for laser and other optical applications has been described in the literature. See, for example. K. Shimamura, “Crystal Growth of Fluorides,” Proc., VI Polish Conf. on Crystal Growth, Poznan, Poland, 20-23 May, 2001, p. 14. This is also described by K. Shimamura, H. Sato, A. Bensalah, V. Sudesh, H. Machida, N. Sarukura and T. Fukuda in “Crystal Growth of Fluorides for Optical Applications,” Cryst. Res. Technol. Vol. 36, 2001 8-10, pp. 801-813, where it was reported that LiCaAlF₆ that was produced in a CF₄ atmosphere had better VUV transmission than LiCaAlF₆ that was processed in an Argon atmosphere.

Before, during or after the machining or polishing steps on LiCaAlF₆ window material, it can be annealed in a fluorine-containing gas such as HF or CF₄ to reduce the internal mechanical stress and fill in lattice voids in the crystal, as know in the art.

Several established methods are available for affixing VUV crystal windows to a glass tube body to form a sealed low-pressure gas lamp. These methods include, for example, glass-to-glass seals, metal film seals, and adhesive seals. The VUV windows of the present invention can also be attached to a lamp body fabricated from a material other than glass, including, without limitation, ceramic or quartz. Choosing materials to reduce or minimize differences between the thermal expansion coefficients of the window and the tube of the lamp can also be beneficial.

The present inventor has discovered that the known mismatch of the linear thermal expansion coefficients along the two axes of thermal expansion of crystals of materials such as LiCaAlF₆ does not prevent use of such materials in the VUV windows of the present invention. With proper alignment of the crystal axes along the cylindrical axis of, for example, a glass lamp body, good seals can be produced by sealing methods known those skilled in the art as described above.

The foregoing description and accompanying drawing set forth several preferred embodiments of the invention. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

1. A VUV lamp comprising an enclosure containing a discharge gas and at least one portion of the enclosure including a VUV transmissive material comprising LiCaAlF₆.

2. The VUV lamp of claim 1 wherein the entire enclosure of the lamp comprises LiCaAlF₆.

3. The VUV lamp of claim 1 wherein a portion of the enclosure other than the VUV transmissive section comprises a material selected from the group glass, ceramic and quartz.

4. The VUV lamp of claim 1 wherein the LiCaAlF₆ material is crystalline.

5. A VUV lamp comprising an enclosure having a discharge gas therein, and at least one portion of the enclosure including a VUV transmissive material comprising crystalline LiCaAlF₆.

6. The VUV lamp of claim 5 wherein the discharge gas comprises nitrogen.

7. The VUV lamp of claim 5 wherein the discharge gas comprises carbon monoxide.
